(19) United States
(12) Patent Application Publication
(10) Pub. No.: US 2003/0212578 A1
(43) Pub. Date: Nov. 13, 2003

(54) Method for obtaining dynamic informed consent

(75) Inventors: Ronald J. Link, Tampa, FL (US); Arthur Epstein, Great Neck, NY (US); Kenneth Keith, Rockville Center, NY (US)

Correspondence Address: DRINKER BIDDLE & REATH, ONE LOGAN SQUARE, 18TH AND CHERRY STREETS, PHILADELPHIA, PA, 19103-6996, US

(73) Assignee: Applied Surgical Data Corporation, Tampa, FL (US)

(21) Appl. No.: 10/299,811

(22) Filed: Nov. 20, 2002

Related U.S. Application Data
(60) Provisional application No. 60/332,223, filed on Nov. 20, 2001.

(51) Int. Cl. G06F 17/60

(52) U.S. Cl. 705/2

(57) ABSTRACT

A method for providing a dynamic, customized patient consent form for informing a patient of the risk of undergoing refractive laser surgery to correct vision by inputting dynamic and semi-static data to create a rule-based algorithm for calculating different risks of undergoing the surgery; drafting different explanatory paragraphs of the different risks; inputting individual patient data; creating a customized risk assessment and assembling a customized consent form by selecting the appropriate explanatory paragraphs.

### CROSS REFERENCE TO RELATED APPLICATION

This application claims priority from U.S. Provisional Application No. 60/332,223, filed Nov. 20, 2001.

### FIELD OF THE INVENTION

The invention relates to determining a patient's risks in undergoing laser surgery for correcting vision and more particularly to creating a dynamic consent form that informs a patient of a customized risk for such surgery.

### OVERVIEW

The invention provides an individualized consent form that alerts a patient as much as measurably possible to the probability of the patient's having a successful outcome in undergoing laser surgery on the eyes to correct vision. The invention also provides a computer-implemented method for creating the consent form utilized from a computer station at a health care provider's office. Using data of known contraindications and complications from FDA guidelines, public manufacturer data, clinical results from professional industry conferences, interdisciplinary scientific literature and negative case law, as well as dynamic data about surgeons' outcome and results history for the surgery, the method calculates in real time a customized risk assessment in terms of the probability of a successful outcome for the patient undergoing surgery by a certain surgeon using a particular surgical device. Based on the customized risk analysis, the method causes a consent form to be generated in real time, which comprises standardized and individualized paragraphs explaining the risks associated with the laser surgery for the patient.

The invention also provides a method whereby a real-time, dynamic informed consent form is created at a computer work station in a contracted health care provider's office by processing specific complication rates and outcome measures for a particular surgical device(s) with which the contracted provider performs refractive laser surgery. Clinical basis process data is fed through algorithms of a rule-based informed consent engine that mathematically arrive at a level of definite and/or probable range or risk for each individual patient. An online word-processing program displays the real-time dynamic informed consent form, which includes outcomes analysis, clinical (pre-and post-op measurements), patient satisfaction (subjective reporting and graphic interface generation), graphics program presenting illustrative charts and graphs, identification of contraindications and complications for a specific surgery and weighted risk based on individual patient pre-op profile. The word processing program changes the paragraphs in the real-time dynamic informed consent form to display the individual patient degree of risk when patient degree of risk is formulated. The patient may be shown at the computer photographs of different kinds of visual aberrations possibly resulting from the surgery and patient testimonials, both positive and negative, to augment written advisement. The dynamic informed consent method is online at the contracted provider's office. Print out may be provided for the patient to take home and review.

The invention provides a computer-implemented method for providing a health care provider a dynamic, customized patient consent form for informing a patient of the risk of undergoing laser surgery to correct vision, said method comprising the steps of:

inputting semi-static data relating to contraindications for and complications of the surgery;

inputting dynamic data relating to contraindications for and complications of the surgery, wherein said data comprise information about the outcome of the surgery for each of the health care provider's surgeons and information about the pre-operative and post-operative care of the health care provider's patients;

from the input semi-static data and the input dynamic data, creating a rule-based algorithm for calculating different risks of undergoing the surgery;

using a word processing program, drafting different paragraphs that explain the different risks of undergoing the surgery;

correlating the different paragraphs to the different risks of undergoing surgery;

inputting data of an individual patient;

calculating a customized risk assessment for the individual patient;

based on the risk assessment, directing the word processing program to assemble a customized consent form by selecting the appropriate paragraphs that explain the risks presented in the customized risk assessment;

periodically inputting updated semi-static data and dynamic data;

from the updated semi-static data and dynamic data, creating an updated rule-based algorithm;

from the updated rule-based algorithm, updating the paragraphs that explain different risks of undergoing the surgery.

### BRIEF DESCRIPTION OF THE DRAWINGS

FIG. 1 illustrates a prior art method of formulating informed consent forms.

FIG. 2 illustrates one embodiment of the present method of developing a dynamic informed consent form.

FIG. 3 illustrates further detail of the embodiment of FIG. 2 by which the clinical basis process may be used to create an iterative rule-based algorithm, and thus, the dynamic informed consent form.

### DETAILED DESCRIPTION

The following definitions are used in this specification.

Contraindications comprise measurable interdisciplinary variables that have pre- and post-operation significance (either absolutely or relatively). Three categories of contraindication are Established, Emerging and Unknown. Contraindications are obtained by the dynamic informed consent method of the present invention from both Semi-Static Data and Dynamic Data.

Semi-static Data comprise information about established or emerging contraindications, which are assigned a mathematical value when possible based on their identification as either established or emerging. Such data are gleaned from the following sources, which list is not intended to be exhaustive:

FDA guidelines, as published;

Individual manufacturer data, when publicly accessible;

Professional industry conferences in terms of clinical results presented to peers in the medical profession;

Interdisciplinary scientific literature, including medical journals and individual clinic and/or physician studies;

Consumer groups, including scientific research done by consumer advocacy groups on complications sustained from refractive laser surgery.

Dynamic Data comprise outcome and results history data of surgeons performing refractive laser surgery. These data do not include individual surgeon or patient identifiers.

Complications comprise measurable compromises of visual or other functioning, which may be permanent or which diminish or disappear over time. Three categories of these are Established, Emerging and Unknown.

The present method provides a comprehensive event-driven consent form which alerts a patient as much as measurably possible to his or her individual degree of risk in developing possible complications in undergoing refractive laser surgery to correct vision. The method goes beyond the present strategy for using chronological-hierarchical information to determine a patient's surgical risk by measuring variables and using streaming data, which are processed by algorithms of an informed consent engine that mathematically arrive at a level of definite and/or probable range or risk for each individual patient.

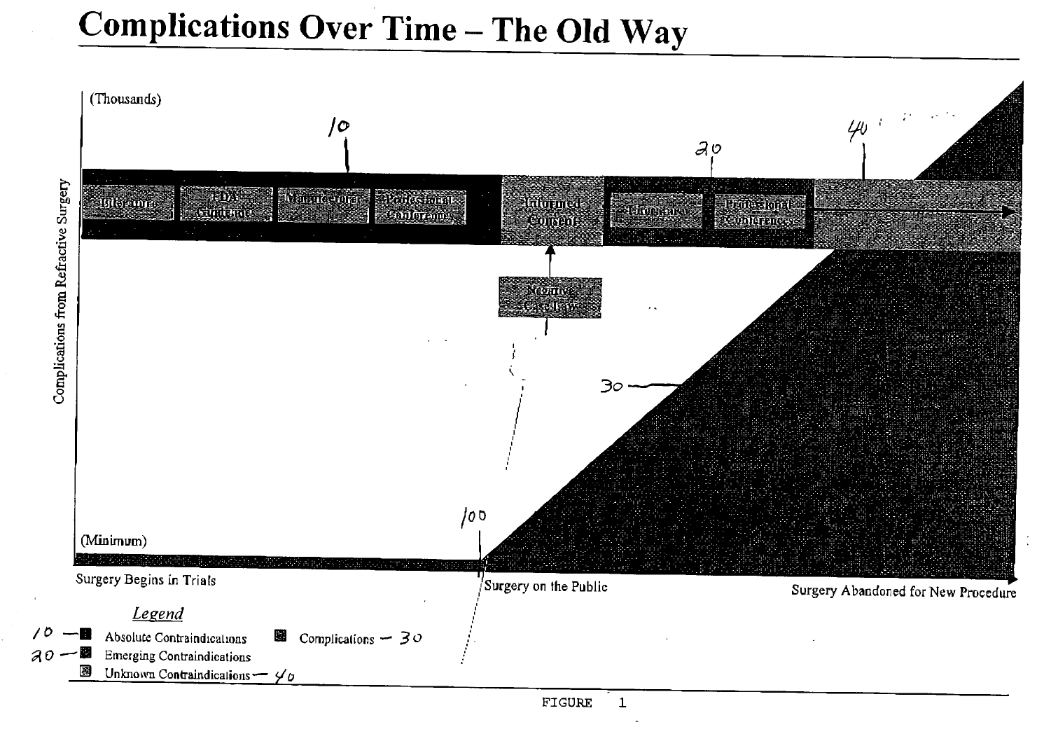

FIG. 1 illustrates a prior art method for providing a patient an informed consent form. As shown, block 10 includes information on the absolute contraindications of refractive laser surgery for correcting vision, which is gathered from the medical literature, FDA guidelines, the manufacturer's warnings and professional conferences. These absolute contraindications have traditionally been used to formulate informed consent forms and to assess risks for patients considering the procedure at point 100, which represents the commencement of surgery on the public. As FIG. 1 shows, once the informed consent form is formulated, there is little or no opportunity in the prior art process to re-formulate the informed consent form so as to include the mounting evidence 30 of complications in performing the procedure. That is, the basis for the informed consent form in the prior art method constitutes almost entirely the absolute contraindications originally formulated before actual practice of the surgical technique on the public. To the point, even though block 20 shows that the medical literature and reports in professional conferences may apprise medical personnel of emerging contraindications of the procedure, the patient may not be receiving this subsequent information. Moreover, the patient is not informed of the mounting data 30 of complications occurring in and or related to the surgery. And, to the extent that there are unknown contraindications to the surgical procedure as shown in block 40, the patient is not informed of these either.

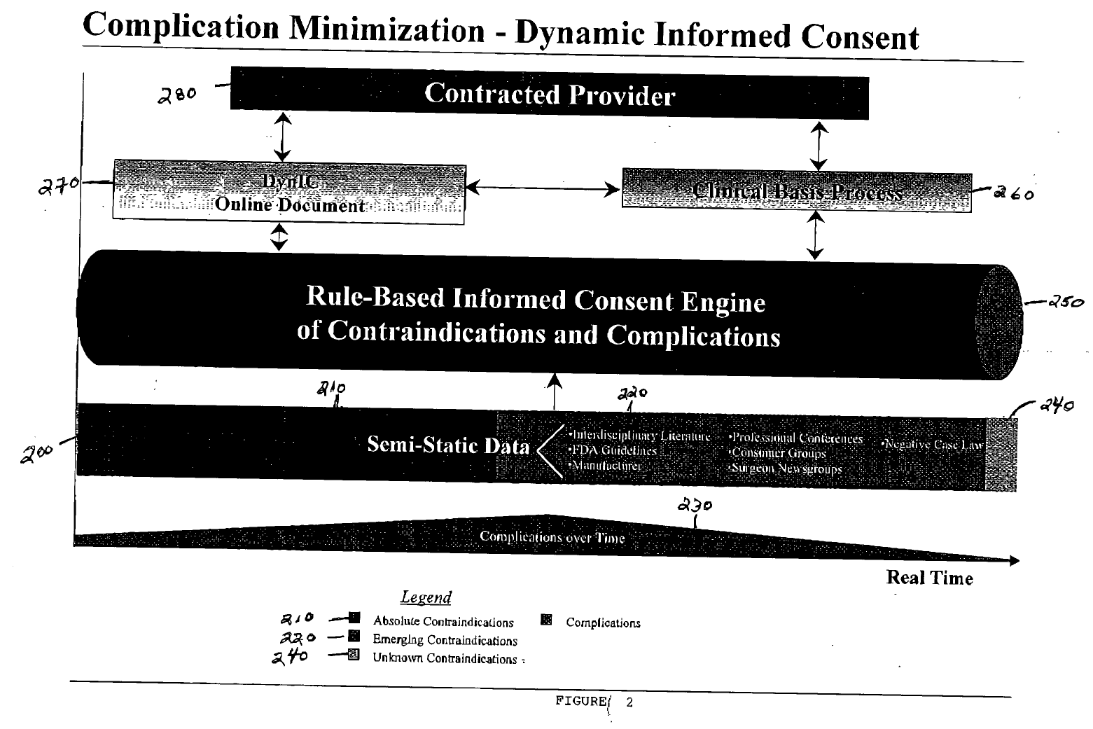

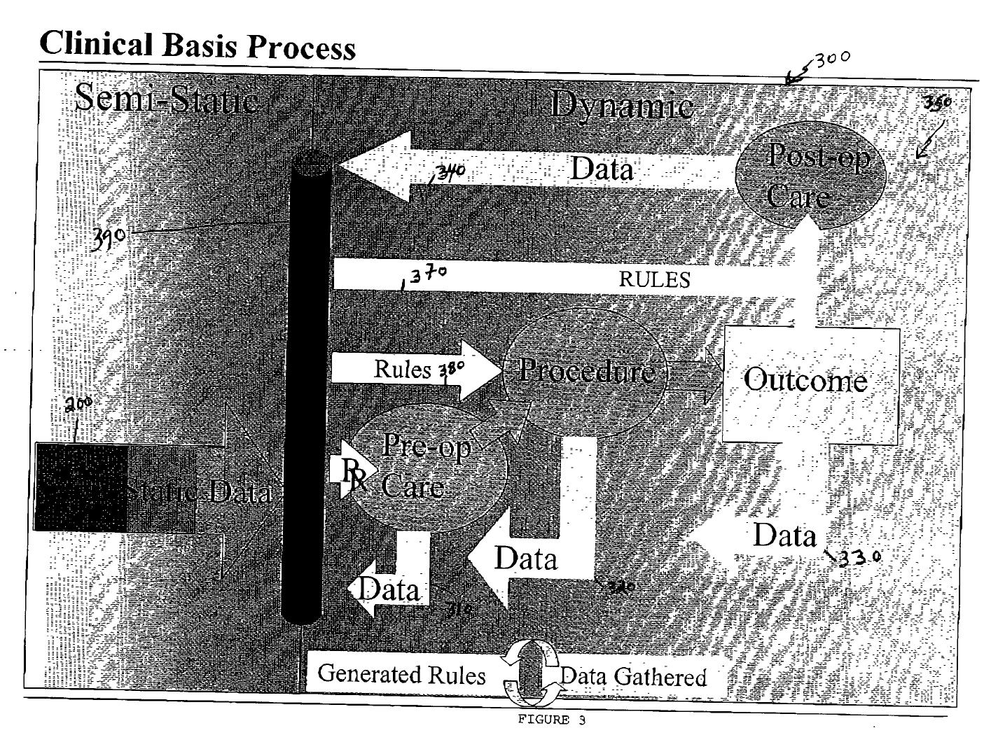

FIG. 2 shows an overview of one embodiment of the present method. A health care provider, such as a hospital, a clinic, physician's practice group or even a solo practitioner contracts to become a participating member in the present method. Participation in the present method provides members the ability to calculate and print out an individualized risk assessment for undergoing refractive laser surgery for the provider's patients. Semi-static data 200, which comprises information on absolute contraindications 210 and emerging contraindications 220, emerging data relating to complications 230 occurring as a result of the surgery are input into the rule-based, informed consent engine 250. The method then calculates using a clinical basis process 260 (shown in more detail in FIG. 3) a customized risk analysis for the patient contemplating laser surgery. Through a connected word processing program, the method prints out a customized Dynamic Informed Consent Form 270 which includes specific paragraphs relating to the patient's customized risk analysis. By contracting to acquire the present method of creating dynamic informed consent forms, a contracted provider can offer a customized informed consent form that details the risks of refractive laser surgery for its patients contemplating the surgery.

FIG. 3 illustrates an embodiment of the clinical basis process 300 in which Semi-static data 200 and Dynamic data 350 are used to generate the rule-based algorithm 390, which shapes the Dynamic Informed Consent Form. The algorithm 390 formulates rules of risks relating to the surgical procedure 380 and rules of risks relating to postoperative events and outcomes 370. In turn, the generated rules 370 and 380 do not remain static but are re-evaluated and re-generated upon the input of data 310 on patients' pre-operative and post-operative care 340, data 320 on the surgical procedure and data 330 on the positive and negative outcomes of the surgery as performed by surgeons associated with the health care provider. The clinical basis process 300 is a real time, iterative calculation of the risks for an individual patient, considering not only the semi-static data of contraindications but also the dynamic data on complications and emerging contraindications, which relate to the outcome and result track record of particular surgeons associated with a contracted health care provider. In other words, the clinical basis process 300 evaluates an individualized patient risk assessment from all the dynamic data on patient outcomes and results of refractive laser surgeries performed by various surgeons of a contracted provider as well as from the semi-static data relating to surgical devices used for the procedure.

Once calculated, the risk assessment is provided in the form of a customized, dynamic informed consent form. This is accomplished by drafting separate sentences or paragraphs that explain different risks and creating a calculus that associates different explanatory sentences or paragraphs with different patient conditions and for different surgeons.

The method is iterative and dynamic in that the clinical basis process 300 may be continually updated with real time data to provide a continually updated rule-based algorithm. That is, as updated data on surgeons' and patients' outcomes and results history are input, the rule-based algorithm both fine-tunes the surgical risks associated with various patient conditions and different surgeons and updates the calculus that associates the risk explanations with these conditions and surgeons. By updating the risk assessment algorithm and the calculus for associating explanations with surgery conditions particularly by inputting dynamic data, the resultant informed consent form may be continually updated and customized for individual patients.

Certain modifications and improvements will occur to those skilled in the art upon a reading of the foregoing description. It should be understood that all such modifications and improvements have been deleted herein for the sake of conciseness and readability. It will be readily apparent that such modifications and improvements could be made therein without departing from the scope of the invention as defined in the following claims.

What is claimed is:

1. A computer-implemented method for providing a health care provider a dynamic, customized patient consent form for informing a patient of the risk of undergoing laser surgery to correct vision, said method comprising the steps of:
a) inputting semi-static data relating to contraindications for and complications of the surgery;
b) inputting dynamic data relating to contraindications for and complications of the surgery, wherein said data comprise information about the outcome of the surgery for each of the health care provider's surgeons and information about the pre-operative and post-operative care of the health care provider's patients;
c) from the input semi-static data and the input dynamic data, creating a rule-based algorithm for calculating different risks of undergoing the surgery;
d) using a word processing program, drafting different paragraphs that explain the different risks of undergoing the surgery;
e) correlating the different paragraphs to the different risks of undergoing surgery;
f) inputting data of an individual patient;
g) calculating a customized risk assessment for the individual patient;
h) based on the risk assessment, directing the word processing program to assemble a customized consent form by selecting the appropriate paragraphs that explain the risks presented in the customized risk assessment;
i) periodically inputting updated semi-static data and dynamic data;
j) from the updated semi-static data and dynamic data, creating an updated rule-based algorithm;
k) from the updated rule-based algorithm, updating the paragraphs that explain different risks of undergoing the surgery;
l) repeating steps e to h.
